(19) United States
(12) Patent Application Publication
(10) Pub. No.: US 2026/0170448 A1
(43) Pub. Date: Jun. 18, 2026

(54) METHOD AND SYSTEM FOR STRATEGIC ADOPTION OF GENERATIVE ARTIFICIAL INTELLIGENCE (AI)

(71) Applicant: UST Global Private Limited, Greater London (GB)

(72) Inventors: Praveen PRABHAKARAN, Ilford (GB); Suraj RAJEEV, Kerala (IN)

(21) Appl. No.: 19/417,386

(22) Filed: Dec. 12, 2025

(30) Foreign Application Priority Data
Dec. 12, 2024 (IN) 202411098299

(51) Int. Cl. G06Q 10/067

(52) U.S. Cl. CPC G06Q 10/067

(57) ABSTRACT

The present subject matter discloses a method (900) for strategic adoption of generative artificial intelligence (AI) within an enterprise. The method (900) includes profiling a plurality of core capabilities that drive value creation in the enterprise based on utilizing an enterprise-standard Business Capability Model and profiling generative AI capabilities based on the plurality of core capabilities. Further, the method (900) includes aligning the generative AI with the plurality of core capabilities by correlating at least one of searching, summarizing, creating, and validation of the generative AI with a plurality of process steps and creating, upon aligning, at least one reusable Scenario card infused with the generative AI capabilities and tailored to enterprise-specific know-how and processes of the enterprise. The method (900) includes deploying the at least one reusable scenario card as strategic levers to guide and scale adoption of generative AI across the enterprise.

### FIELD OF THE INVENTION

The present disclosure generally relates to the field of generative artificial intelligence (AI). More particularly, the present disclosure relates to a method and a system for strategic adoption of the generative AI for an enterprise.

### BACKGROUND

The information in this section merely provides background information related to the present disclosure and may not constitute prior art(s) for the present disclosure.

Conventionally, generative artificial intelligence (AI) is designed to produce new content such as text, images, audio, video, software code, and other outputs by learning patterns and structures from existing datasets.

Despite the growing interest in generative AI, many enterprises and organizations encounter substantial challenges when attempting to adopt and operationalize the generative AI. These challenges often arise from factors including an emphasis on superficial or isolated use cases, the absence of a cohesive strategic framework, difficulties associated with deployment at scale, and similar impediments.

For example, enterprises frequently prioritize high-visibility or experimental generative AI applications that appear novel or innovative on their own. While these use cases of the generative AI may generate initial enthusiasm, they often fail to identify areas where generative AI can create sustained and meaningful business value.

As a result, a strategic gap commonly emerges, where the generative AI initiatives are pursued without a well-defined roadmap that aligns the technology with core organizational objectives. Without such alignment, enterprises encounter difficulties integrating the generative AI workflows, leading to fragmented or inconsistent implementations. Consequently, the generative AI efforts often remain disconnected from broader business priorities, limiting the ability of organizations to fully harness the technology's potential and reduce its impact on enterprise-wide, scalable outcomes.

Furthermore, traditional approaches present significant deployment barriers. Effectively scaling and operationalizing generative AI in a manner that provides consistent, measurable value over time is challenging. Many organizations face obstacles such as insufficient computational infrastructure, limited specialized expertise, and the complexity of incorporating generative AI into legacy systems and processes. These issues hinder the transition from initial pilot projects to sustainable, long-term contributions that support meaningful business transformation.

Accordingly, there is a need to provide techniques to solve the above-mentioned and other related problems.

The drawbacks/difficulties or the disadvantages/limitations of conventional techniques explained in the background section are just for exemplary purposes and the disclosure would never limit its scope only such limitations. A person skilled in the art would understand that this disclosure and below mentioned description may also solve other problems or overcome the other drawbacks/disadvantages of the conventional arts which are not explicitly captured above.

### SUMMARY

This summary is provided to introduce a selection of concepts, in a simplified format, that are further described in the detailed description of the invention. This summary is neither intended to identify key or essential inventive concepts of the invention nor is it intended for determining the scope of the invention.

The present subject matter discloses a method for strategic adoption of generative artificial intelligence (AI) within an enterprise. The method includes profiling a plurality of core capabilities that drive value creation in the enterprise based on utilizing an enterprise-standard Business Capability Model (BCM). The method includes profiling generative AI capabilities based on the plurality of core capabilities. Further, the method includes aligning, upon profiling, the generative AI with the plurality of core capabilities by correlating at least one of searching, summarizing, creating, and validation of the generative AI with a plurality of process steps associated with the plurality of core capabilities. Furthermore, the method includes creating, upon aligning, at least one reusable scenario card infused with the generative AI capabilities and tailored to enterprise-specific know-how and processes of the enterprise. Lastly, the method includes deploying the at least one reusable scenario card as strategic levers to guide and scale adoption of generative AI across the enterprise.

In another embodiment, a system for strategic adoption of generative artificial intelligence (AI) within an enterprise is disclosed. The system includes a memory and at least one processor. The at least one processor is configured to profile a plurality of core capabilities that drive value creation in the enterprise based on utilizing an enterprise-standard Business Capability Model (BCM). The at least one processor is configured to profile generative AI capabilities based on the plurality of core capabilities. Further, the at least one processor is configured to align, upon profiling, the generative AI with the plurality of core capabilities by correlating at least one of searching, summarizing, creating, and validating of the generative AI with a plurality of process steps associated with the plurality of core capabilities. Furthermore, the at least one processor is configured to create at least one reusable scenario card infused with the generative AI capabilities and tailored to enterprise-specific know-how and processes of the enterprise. Lastly, the at least one processor is configured to deploy the at least one reusable scenario card as strategic levers to guide and scale adoption of the generative AI across the enterprise.

To further clarify the advantages and features of the present invention, a more particular description of the invention will be rendered by reference to specific embodiments thereof, which are illustrated in the appended drawings. It is appreciated that these drawings depict only typical embodiments of the invention and are therefore not to be considered limiting of its scope. The invention will be described and explained with additional specificity and detail with the accompanying drawings.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 illustrates an environment having a system for strategic adoption of generative artificial intelligence (AI) within an enterprise, in accordance with an embodiment of the present disclosure;

FIG. 2 illustrates a detailed block diagram of the system for strategic adoption of the generative artificial intelligence (AI) within the enterprise, in accordance with an embodiment of the present disclosure;

FIG. 3 illustrates an architecture of the system for strategic adoption of the generative AI, in accordance with the embodiment of the present disclosure;

FIG. 4 illustrates an operation performed by the system for strategic adoption of the generative AI, in accordance with the embodiment of the present disclosure;

FIG. 5 illustrates a profiling of the generative artificial intelligence (AI), in accordance with an embodiment of the present disclosure;

FIG. 6 illustrates an implementation of a process of creation and distribution of marketing content, in accordance with the embodiment of the present disclosure;

FIG. 7 illustrates an implementation of a process of supplier contract management, in accordance with the embodiment of the present disclosure;

FIG. 8 illustrates an implementation of a process of loss prevention and management, in accordance with the embodiment of the present disclosure; and

FIG. 9 illustrates a flow diagram of a method performed by the system for strategic adoption of the generative artificial intelligence (AI) within the enterprise, in accordance with the embodiment of the present disclosure.

Further, skilled artisans will appreciate that elements in the drawings are illustrated for simplicity and may not have necessarily been drawn to scale.

Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having the benefit of the description herein.

### DETAILED DESCRIPTION OF FIGURES

For the purpose of promoting an understanding of the principles of the present disclosure, reference will now be made to the various embodiments and specific language will be used to describe the same. It will nevertheless be understood that no limitation of the scope of the present disclosure is thereby intended, such alterations and further modifications in the illustrated system, and such further applications of the principles of the present disclosure as illustrated therein being contemplated as would normally occur to one skilled in the art to which the present disclosure relates.

It will be understood by those skilled in the art that the foregoing general description and the following detailed description are explanatory of the present disclosure and are not intended to be restrictive thereof.

Whether or not a certain feature or element was limited to being used only once, it may still be referred to as “one or more features” or “one or more elements” or “at least one feature” or “at least one element.” Furthermore, the use of the terms “one or more” or “at least one” feature or element do not preclude there being none of that feature or element, unless otherwise specified by limiting language including, but not limited to, “there needs to be one or more . . . ” or “one or more elements is required.”

Reference is made herein to some “embodiments.” It should be understood that an embodiment is an example of a possible implementation of any features and/or elements of the present disclosure. Some embodiments have been described for the purpose of explaining one or more of the potential ways in which the specific features and/or elements of the proposed disclosure fulfil the requirements of uniqueness, utility, and non-obviousness.

Use of the phrases and/or terms including, but not limited to, “a first embodiment,” “a further embodiment,” “an alternate embodiment,” “one embodiment,” “an embodiment,” “multiple embodiments,” “some embodiments,” “other embodiments,” “further embodiment”, “furthermore embodiment”, “additional embodiment” or other variants thereof do not necessarily refer to the same embodiments. Unless otherwise specified, one or more particular features and/or elements described in connection with one or more embodiments may be found in one embodiment, or may be found in more than one embodiment, or may be found in all embodiments, or may be found in no embodiments. Although one or more features and/or elements may be described herein in the context of only a single embodiment, or in the context of more than one embodiment, or in the context of all embodiments, the features and/or elements may instead be provided separately or in any appropriate combination or not at all. Conversely, any features and/or elements described in the context of separate embodiments may alternatively be realized as existing together in the context of a single embodiment.

Any particular and all details set forth herein are used in the context of some embodiments and therefore should not necessarily be taken as limiting factors to the proposed disclosure.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Embodiments of the present disclosure will be described below in detail with reference to the accompanying drawings.

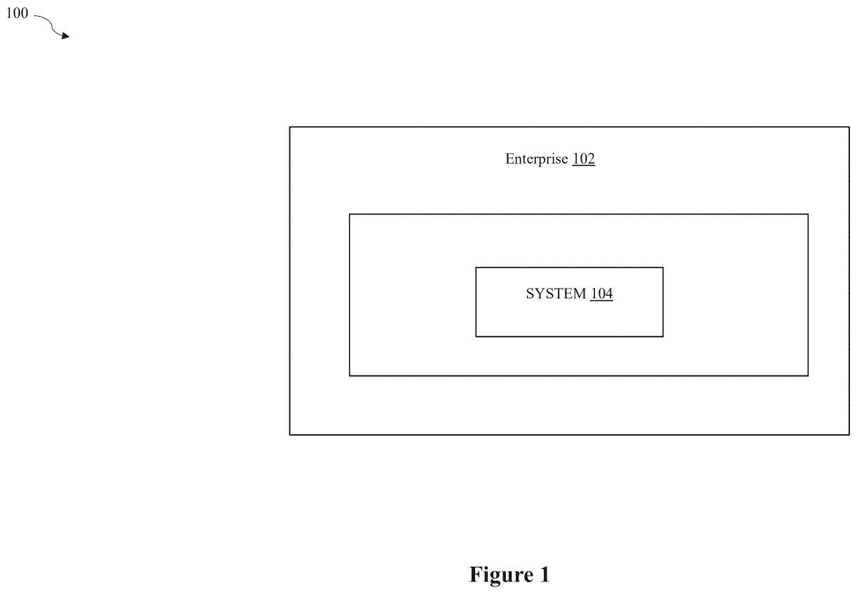

FIG. 1 illustrates an environment 100 having a system 104 for strategic adoption of generative artificial intelligence (AI) within an enterprise 102, in accordance with an embodiment of the present disclosure.

In an embodiment, the system 104 for the strategic adoption of generative artificial intelligence (AI) within the enterprise 102 is disclosed. The enterprise 102 may be an organization or a company. Further, it should be noted that the enterprise 102, organization, and company are hereinafter commonly referred to as “enterprise”. The generative AI may be an artificial intelligence system capable of generating new content, such as text, images, video, or code, based on input data. The capabilities of generative AI may enhance processes by automating tasks, creating content, summarizing data, and improving search, driving efficiency and innovation across industries. The generative AI may provide a range of capabilities that may transform business operations by optimizing processes and driving efficiency. The generative AI capabilities may be further categorized into search, summarization, creation, and validation, each addressing specific operational needs. By leveraging the same, the enterprise 102 may streamline workflows, reduce manual effort, and generate new value. For instance, search is the ability to quickly and accurately extract relevant information from vast data sources. Summarization is the capability to condense large volumes of data or text into concise, meaningful summaries. Creation is the ability to generate original content, including text, images, videos, and other media forms. Validation is the capability to assess and verify data or generated content, ensuring accuracy, consistency, and compliance with standards. The capabilities of generative AI in search, summarization, creation, and validation are powerful tools for optimizing processes and unlocking new levels of operational efficiency.

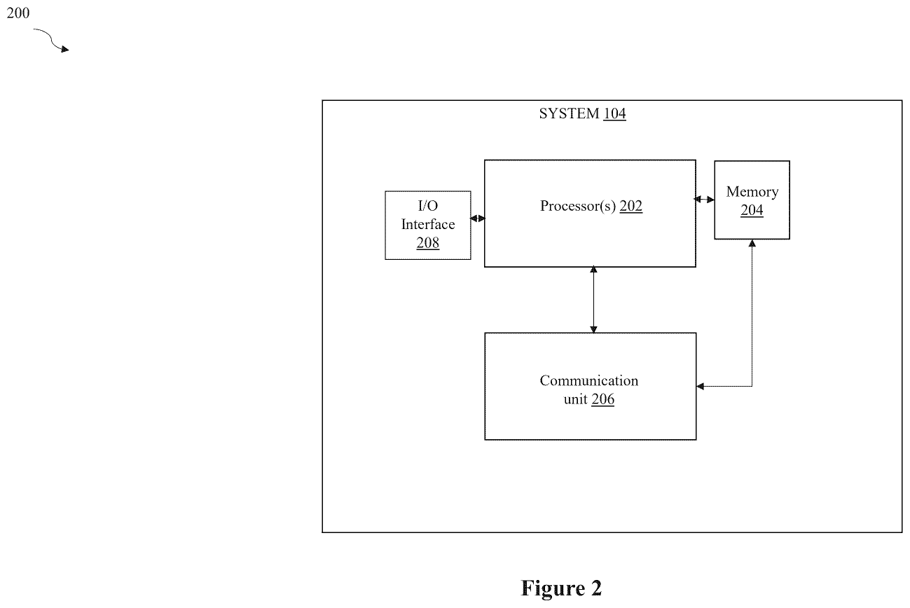

FIG. 2 illustrates a detailed block diagram 200 of the system 104 for the strategic adoption of the generative artificial intelligence (AI) within the enterprise 102, in accordance with an embodiment of the present disclosure.

The system 104 may include one or more processors (referred to herein as a processor) 202, one or more memories (referred to herein as a memory) 204, a communication unit 206, and an input/output (I/O) interface 208. The system 104 may correspond to one of a server at a user location, a remote server, a user device, or any other electronic device. In one or more embodiments, the system 104 may include a combination of an electronic device and a server.

The processor(s) 202 can be a single processing unit or several units, all of which could include multiple computing units. The processor 202 may be in communication with the memory 204. The processor 202 may be implemented as one or more microprocessors, microcomputers, microcontrollers, digital signal processors, central processing units, state machines, logic circuitries, and/or any devices that manipulate signals based on operational instructions. Among other capabilities, the processor 202 is configured to fetch and execute computer-readable instructions and data stored in the memory 204.

The memory 204 includes one or more computer-readable storage media. The memory 204 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory may, in some examples, be considered a non-transitory storage medium. The term “non-transitory” may indicate that the storage medium is not embodied in a carrier wave or a propagated signal. However, the term “non-transitory” should not be interpreted to mean that the memory is non-movable. In certain examples, a non-transitory storage medium may store data that can, over time, change (e.g., in Random Access Memory (RAM) or cache.

The memory 204 may further include any non-transitory computer-readable medium known in the art including, for example, volatile memory, such as static random-access memory (SRAM) and dynamic random-access memory (DRAM), and/or non-volatile memory, such as read-only memory (ROM), erasable programmable ROM, flash memories, hard disks, optical disks, and magnetic tapes.

The communication unit 206 is configured to communicate data or any other signal over a communication network. Further, the communication unit 206 may include a communication port, a communication interface, or a transceiver for sending and receiving signals from the system 104 via the communication network. The communication port or the communication interface may be a part of a processing unit or may be a separate component. The communication port may be created in software or may be a physical connection in hardware. The communication port may be configured to connect with the communication network, external media, the display, or any other components in the system 104, or combinations thereof. The connection with the communication network may be a physical connection, such as a wired Ethernet connection, or may be established wirelessly, as discussed above. Likewise, the additional connections with other components of the system 104 may be physical or may be established wirelessly.

The I/O interface 208 refers to hardware or software components that enable communication between the system 104 and any other electronic device. The I/O interface 208 serves as a communication medium for exchanging information, commands, signals, or query responses with other devices or systems. The I/O interface 208 may be a part of the processor 202 or maybe a separate component. The I/O interface 208 may be created in software or maybe a physical connection in hardware. The I/O interface 208 may be configured to connect with an external network, external media, the display, or any other components, or combinations thereof. The external network may be a physical connection, such as a wired Ethernet connection, or may be established wirelessly.

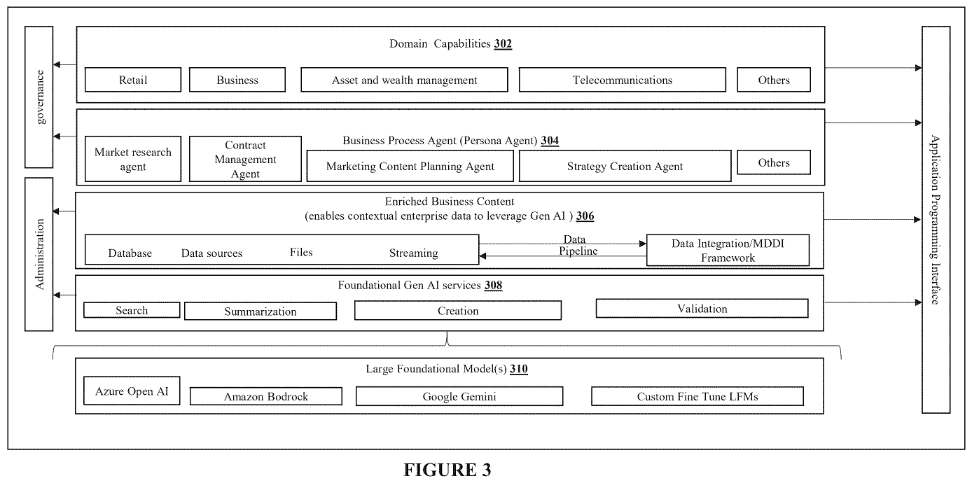

In one or more embodiments, one or more functions associated with the system 104 may be performed through the non-volatile memory, the volatile memory, and the processor 202 as explained in FIGS. 3 to 8 in conjunction with FIG. 2.

FIG. 3 illustrates an architecture of the system 104 for the strategic adoption of the generative AI, in accordance with the embodiment of the present disclosure.

The architecture illustrated in FIG. 3 is an exemplary architecture as the implementations of the present application are not limited thereto. The architecture provides a structured, modular approach to integrating the generative AI across the enterprise 102, ensuring scalability, flexibility, and alignment with business goals. For example, the integration may be based on domain capabilities 302, business process agents (persona-based) 304, Enriched Business Context 306, Foundational GenAI Services 308, and Large Foundation Models (LFMs) 310.

In an embodiment, the domain capabilities 302 may define industry-specific requirements that ensure AI solutions are compliant and relevant to each domain powered by Business Capability Model. The domain capabilities 302 may provide tailored configurations to support distinct regulatory and operational needs. Herein, the domain capabilities may include, but is not limited to, retail, business, asset and wealth management, telecommunications, and others.

In an embodiment, the business process agent 304 may be the persona-driven AI agents that automate specific processes, enhancing roles with AI-driven insights and actions. For example, the business persona-driven AI agent may be a marketing associate. The business process agent 304 may act as intermediaries that use foundational AI services for role-specific tasks. Herein, the business process agent 304 may include, but is not limited to, a market research agent, a contract management agent, a marketing content planning agent, a strategy creation agent, and others.

In an embodiment, the enriched business context 306 may integrate data sources through a data pipeline to enrich the generative AI with real-time, contextual enterprise data. For example, the data sources may be databases, files, or streams. In one example, the data pipeline may be the Model-Driven Data Integration (MDDI) framework. The enriched business context 306 may ensure that AI outputs are relevant and data-informed. Herein, the enriched business context 306 may include, but is not limited to, database, data sources, files, and streaming.

In an embodiment, the foundational GenAI services 308 may be core AI services offering reusable functionalities for enterprise tasks. In one example, the core AI services may be search, summarization, creation, and validation. The core AI services may interface with business agents and enriched data, enabling versatile, modular AI capabilities accessible via APIs.

In an embodiment, the Large Foundation Models (LFMs) 310 may support AI services with robust models and custom fine-tuned models tailored to enterprise needs. In an example, the robust models may be, for example, Azure OpenAI, Google Gemini, and Amazon Bedrock. The LFMs may power 310 foundational GenAI services with advanced machine-learning capabilities.

Further, each of the domain capabilities 302, the business process agent 304, the enriched business content 306, the foundational GenAI services 308 may be in communication with an application programming interface. Further, each of the domain capabilities 302, the business process agent 304, may be a part of the governance. Furthermore, the enriched business content 306, the foundational GenAI services 308, may be a part of an administration.

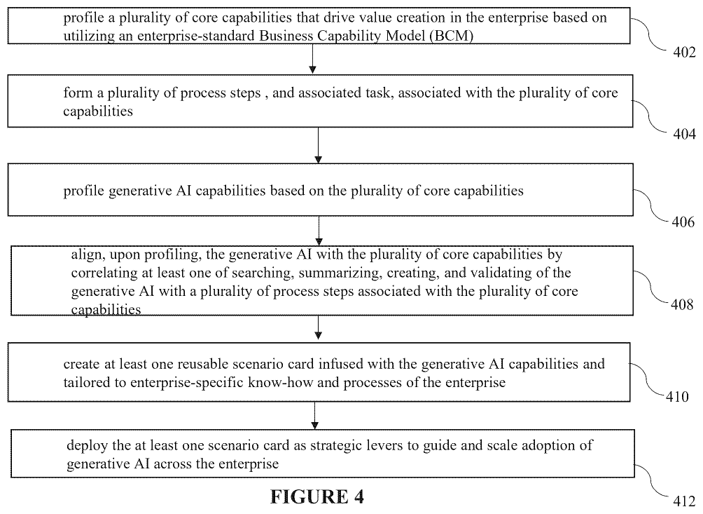

Further, the detailed operation performed by the system 104 may be explained in the subsequent paragraphs with respect to FIG. 4

FIG. 4 illustrates an operation performed by the system 104, in accordance with an embodiment of the present disclosure.

In an embodiment, at block 402, the processor 202 may be configured to profile the plurality of core capabilities that drive value creation in the enterprise 102 based on utilizing an enterprise-standard Business Capability Model (BCM). Further, the BCM may be industry-specific. Herein, the processor 202 may be configured to analyze and utilize the BCM to profile the plurality of core capabilities. The BCM may include an industry-standard framework selected from predefined process classification framework. This configuration ensures relevance and effectiveness in different business domains.

In such an embodiment, the processor 202 may be configured to list the plurality of core capabilities of the enterprise 102 based on an identification of the plurality of core capabilities. Further, the processor 202 may be configured to profile the plurality of core capabilities that drive value creation in the enterprise 102 based on utilizing the enterprise-standard BCM.

In an embodiment, the BCM may refer to a structured framework that outlines a core business functions of the organization and value-creating processes. The BCM provides a high-level view of what the organization does, helping align business activities with strategic objectives. Particularly, the BCM may be referred to as a comprehensive map outlining the enterprise's capabilities that deliver value to its customers.

In an embodiment, at block 404, the processor 202 may be configured to form a plurality of process steps associated with the plurality of core capabilities based on segmenting the plurality of core capabilities. Herein, initially, the processor 202 may be configured to form a plurality of processes and, accordingly, the plurality of process steps suitable for the application of the generative AI based on the BCM. The processor 202 may be configured to determine at least one task associated with the plurality of core capabilities based on the plurality of process steps.

Further, in an embodiment, each of the plurality of processes may be defined as operational actions within a capability that contribute to value creation. For example, a process may be a series of structured activities that define how a business capability may be executed. Further, each of the plurality of process steps may be individual tasks or actions that make up a process. In another embodiment, each of the plurality of process steps may be granular steps that break down processes into actionable tasks, providing a clear view of how activities are carried out and where the generative AI may be applied for optimization or improvement.

In an embodiment, at block 406, the processor 202 may be configured to profile generative AI capabilities based on the plurality of core capabilities.

In such an embodiment, the processor 202 may be configured to identify the plurality of process steps. Further, the processor 202 may be configured to validate, upon identification, the plurality of process steps with respect to a plurality of criteria associated with the generative AI. The plurality of criteria may include desirability, feasibility, viability, adaptability, and compliance associated with the generative AI. The processor 202 may be configured to profile the generative AI capabilities based on the validation.

Herein, the processor 202 may be configured to perform validating processes with a multi-layered process for profiling the generative AI. Before deploying Generative AI solutions, each process step may be validated to ensure that the generative AI solution aligns with organizational goals and can deliver measurable benefits. Particularly, validating processes with the multi-layered process may be the function that validates each process step. Each process step may be validated against five criteria, including desirability, feasibility, viability, adaptability, and compliance. In case of desirability, validation may be assessed by determining whether the application of generative AI addresses a significant business need or pain point within the process. Feasibility may be assessed by determining whether the application of current generative AI technologies and resources supports the process. Viability may be assessed by determining whether the expected benefits (e.g., cost savings, efficiency gains) outweigh the costs of implementing generative AI in the process. Adaptability may be assessed by determining whether the application of generative AI scale adapts to changing business needs or future process variations. Compliance may be assessed by determining whether the application of the generative AI in the process meets the necessary regulatory and compliance standards.

In an embodiment, at block 408, the processor 202 may be configured to align, upon profiling, the generative AI with the plurality of core capabilities by correlating at least one of searching, summarizing, creating, and validating of the generative AI with the plurality of process steps associated with the plurality of core capabilities.

In such an embodiment, the processor 202 may be configured to perform a search by the generative AI based on an assessment that the generative AI is able to retrieve information from the plurality of core capabilities. The processor 202 may be configured to perform summarization by the generative AI based on an assessment that the generative AI is able to condense at least one of the dataset or documents associated with the plurality of core capabilities. The processor 202 may be configured to perform a creation by the generative AI based on an assessment that the generative AI is able to create new content or insights associated with the plurality of core capabilities based on user input. The processor 202 may be configured to perform validation by the generative AI based on an assessment that the generative AI is able to validate one of the data or a result associated with the plurality of core capabilities.

Further, the processor 202 may be configured to map the generative AI with each of the plurality of core capabilities based on correlating at least one of searching, summarizing, creating, and validating of the generative AI with the plurality of process steps. The processor 202 may be configured to assign a suitability score for each mapping. Furthermore, the processor 202 may be configured to align the generative AI capabilities with the plurality of core capabilities based on the suitability score.

Herein, particularly, the processor 202 may be configured to map each process step to relevant generative AI capabilities such as search, summarization, creation, or validation to ensure each the generative AI application is aligned with the area where it can deliver the most value. Thereafter, the processor 202 may be configured to assign the suitability score for each mapping. The suitability scoring may be at least one of “major, minor, or not applicable.”. Particularly, mapping processes to the generative AI capabilities may be the function that maps each process step to the relevant generative AI capabilities and assigns the suitability score (major, minor, or not applicable). The scale of major, minor, or not applicable may be used to evaluate the impact the generative AI may have along, with search, summarization, creation, and validation.

In scoring and prioritizing processes, each process may be scored based on the five validation filters (on a scale of high, medium, or low) to prioritize those with the highest potential impact. Herein, scoring and prioritizing processes may be the function that calculates a total score for each process step based on the validation filters and sorts them by priority. Herein, the scoring and prioritizing processes may include a scoring system, assigning scores, calculating aggregate scores, calculating aggregate scores, and prioritizing processes. In the case of the scoring, the score may be one of high, low, or medium. The score may be high when there is an alignment with enterprise needs and high feasibility for implementation. The score may be medium when there is moderate alignment or potential impact. Further, the score may be low when there is weak alignment or challenging to implement due to feasibility concerns. In the case of the filter of assigning scores, each process may be evaluated against the five validation filters and a score is assigned. Furthermore, in the case of the filter of calculating aggregate scores, individual scores may be combined to determine the overall viability of each process for AI implementation. In the case of prioritizing processes, processes may be ranked based on respective scores, focusing on the one with the highest potential impact and ease of implementation.

In an embodiment, at block 410, the processor 202 may be configured to create at least one reusable scenario card infused with the generative AI capabilities and tailored to enterprise-specific know-how and processes of the enterprise. The at least one reusable scenario card may include, but is not limited to, process steps, system integration requirements, business rules, enterprise know-how, triggers, and actions for applying generative AI capabilities. Herein, the at least one reusable scenario card may incorporate the specific generative AI capabilities aligned with the enterprise's processes. For example, a scenario may be a specific use case or situation where the generative AI can be applied to improve the process. Scenarios may help identify opportunities where AI capabilities can enhance efficiency, automate tasks, or create new value within a business context. For example, the scenario card may be a reusable strategic tool that maps the generative AI capabilities, such as search, summarization, creation, and validation, to specific processes. The Scenario cards may include business rules, unique enterprise know-how, system integration requirements, and process steps, ensuring consistent and scalable AI adoption across the organization.

In an embodiment, at block 412, the processor 202 may be configured to deploy the at least one reusable scenario card as strategic levers to guide and scale the adoption of generative AI across the enterprise 102. Herein, the processor 202 may be configured to distribute and implement the at least one reusable scenario card across the enterprise 102 for scalable generative AI adoption. This configuration ensures scalable and efficient adoption of Generative AI throughout the enterprise.

The scenario cards may be reusable strategic levers designed to accelerate generative AI deployment across different business units. The scenario cards may ensure consistent and impactful integration of the generative AI throughout the organization. The scenario cards may be reusable strategic levers that map the generative AI capabilities such as search, summarization, creation, and validation, directly to specific processes, incorporating an enterprise's unique knowledge and expertise. The scenario cards may ensure consistency and scalability in the adoption of the generative AI across the organization, embedding AI into core operations rather than implementing it as isolated experiments. By providing a structured framework, scenario cards allow for repeatable and adaptable AI solutions across various departments or business units. Therefore, ensuring that the deployment of the generative AI may be scalable and may be consistently aligned with business objectives.

In an embodiment, the scenario cards may include specific instructions for applying the generative AI capabilities to processes, ensuring seamless integration into existing workflows.

In an embodiment, the scenario cards may be designed to be scalable and adaptable across different industries, allowing enterprises to customize the methodology according to their specific needs.

The key elements of scenario cards may be process steps, system integration, business rules and enterprise know-how, and triggers and actions. For example, in the process steps, each scenario card may be aligned with underlying processes at the process step level, clearly defining how that step is enhanced or transformed by the generative AI. In another example, the system integration specifies the systems and integrations required to effectively deploy the scenario card within the existing business ecosystem. In one example, the business rules and enterprise know-how capture the unique business rules and operational knowledge of the enterprise that may guide the application of the generative AI, ensuring solutions are tailored to the specific needs of the enterprise. In yet another example, the triggers may define whether the generative AI-driven processes are activated manually or automatically, and the actions may outline the specific tasks or actions performed with the support of the generative AI, ensuring clear and actionable AI-driven outcomes.

Further, in another embodiment, the techniques of the present subject matter provide a software-based solution that facilitates profiling the generative AI and the creation and deployment of the scenario cards, enabling scalable and efficient adoption of the generative AI throughout the enterprise.

In an embodiment, the scenario card creation may allow for customization of scenario cards, enabling enterprises to tailor the generative AI applications to their unique processes. The scenario cards may provide a consistent way for scaling the generative AI initiatives, ensuring they are integrated across the enterprise with strategic intent and operational relevance. In an example, the scenario cards may be created by identifying key processes for AI Integration, then selecting the optimal Generative AI capability and designing the workflow and parameters. Thereafter, customizing for enterprise needs and establishing KPIs for success. Identifying key processes for AI Integration may be the function that identifies processes that may be high-impact and align with strategic goals, focusing on the processes that would benefit most from the generative AI. To identify key processes for the AI Integration, the steps involve building upon the profiling step, focusing on processes that may be identified as high impact areas for the generative AI adoption. These processes may be aligned with the enterprise's strategic goals and offer the greatest potential for optimization through Generative AI.

Further, selecting the optimal generative AI capability may be the function that selects the most suitable the generative AI capability (e.g., search, summarization, creation, or validation) that directly addresses the identified inefficiencies in each process. The selection of the optimal generative AI capability may be based on the process and its requirements. Selecting the most suitable generative AI capability, whether it be search, summarization, creation, or validation may be identified during the profiling stage. This, in turn, may ensure that the AI solution directly addresses identified pain points or inefficiencies within the process.

Design workflow and parameters may be the function that creates a detailed workflow for the scenario card, including triggers that may be manual or automatic, actions to be performed, such as summarization or validation, data inputs required for AI functionality, and expected outputs as outcomes of the AI-driven process. Designing workflow and parameters may be performed by defining a detailed workflow for the scenario card, which includes triggers, actions, data inputs, and expected outputs. In this example, the triggers may be whether the process is initiated manually or automatically by specific events. Actions may be the tasks performed by the generative AI, such as content generation, summarizing reports, or validating data for accuracy and consistency. Data inputs may be the required inputs for generative AI to function effectively. Expected outputs may be the tangible results or outcomes generated by AI in the process.

Customizing for enterprise needs may be the function that customizes the workflow to align with the enterprise's unique business rules, operational knowledge, and any necessary regulatory standards. Customizing for enterprise needs may be performed by adapting the scenario card to align with the unique business rules, operational knowledge, and strategic objectives of the enterprise. As a result, the customization may ensure that the generative AI solution fits seamlessly within the existing processes and culture of the enterprise, while also delivering tailored value. The customization phase also integrates any specific regulatory requirements or compliance standards that must be adhered to within the operations of the enterprise.

Establishing KPIs for success may be the function that defines KPIs directly tied to business outcomes, such as efficiency, cost reduction, decision-making speed, accuracy, and quality. The defined KPIs may help measure the success of the Scenario card after implementation. Establishing KPIs for success may be performed by defining clear KPIs that may measure the success of the scenario card once implemented. The defined KPIs may be directly tied to business outcomes, such as increased efficiency, reduced costs, improved decision-making speed, enhanced accuracy, or quality of outputs.

In another embodiment, the system 104 includes a feedback mechanism for continuous performance monitoring and optimization of scenario cards, allowing for ongoing improvements and adaptability over time. In an embodiment, the feedback mechanism may be configured to collect performance data from deployed scenario cards, allowing for continuous improvement and optimization of generative AI adoption strategies.

Thus, the processor 202, along with the BCM, may aid in identifying where the generative AI capabilities, such as search, summarization, creation, and validation may deliver the most value. The processor 202, along with the BCM, may connect generative AI initiatives to the core business goals of the enterprise by visualizing operational processes and identifying where the generative AI may enhance efficiency and create value. The processor 202, along with the BCM, may provide strategic alignment, map generative AI capabilities, and avoid fragmentation. In the case of providing strategic alignment, the processor 202, along with the BCM, ensures that the generative AI initiatives are not isolated experiments but are strategically aligned with the enterprise's long-term objectives. This alignment guarantees that the generative AI contributes meaningfully to the overall success of the enterprise, avoiding fragmented efforts that lack impact. Further, the processor 202, along with the BCM, may map the generative AI capabilities to specific process steps and then identify where the generative AI can deliver the greatest value. As a result, the enterprise focuses on high-impact use cases, avoiding unnecessary investments in areas that may not yield significant returns. Additionally, the processor 202, along with the BCM, ensures that deployment of the generative AI may be directly tied to the strategic goals of the enterprise. Thus, the disclosed techniques may avoid fragmented generative AI implementations that may not contribute value to core operations, ensuring a cohesive and value-driven generative AI strategy.

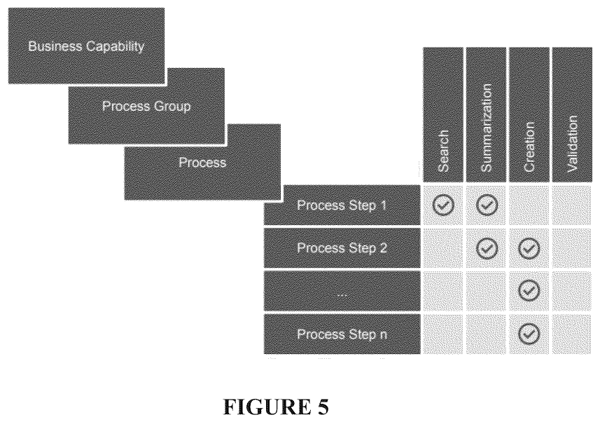

FIG. 5 illustrates the profiling of the generative AI, in accordance with an embodiment of the present disclosure.

Particularly, referring to FIG. 5, the processor 202 may be configured to identify the generative AI corresponding to the plurality of core capabilities and identify areas within the BCM where the generative AI may provide the most value and support business goals. In this case, in order to successfully adopt the generative AI, the enterprises may profile respective processes and map the same to the appropriate generative AI capabilities. The techniques may include analyzing workflows within each business capability to identify where the generative AI may deliver the most value. Further, the processor 202 along with the BCM may be configured to map the plurality of core capabilities and, decompose business capabilities to the process step levels, document process steps, identify pain points, identify generative AI opportunities, map processes to generative AI capabilities, validate processes with a multi-layered process, scoring and prioritizing processes which may be explained in detail in the subsequent paragraphs.

Herein, the processor 202, along with the industry-standard BCM, such as American Productivity and Quality Center (APQC's) Process Classification Framework (PCF) may be used to map the plurality of core capabilities. The processor 202, along with the BCM, may map the plurality of core capabilities by identifying and listing all core capabilities of the enterprise. These core capabilities may form the foundation for identifying the generative AI opportunities within the enterprise 102. The mapping of the enterprise's core capabilities may be the function that loads the BCM and maps core capabilities, returning a list.

Further, the BCM may break down each business capability into process groups, the plurality of processes and further into individual process step levels to decompose the business capabilities to the process step level. Particularly, decomposing business capabilities may be the function that breaks down each capability into process groups, each of the plurality of processes, and each process step, creating a detailed structure of tasks. As a result of the detailed breakdown, a granular view of specific tasks may be provided that can be optimized with the generative AI.

In an embodiment, the process may, for instance, but not limited thereto, be the creation and distribution of marketing content. For example, the process may belong to the market products and services capability. The business capability may be market products and services capability, the process group may be market to customers, and the process may be the creation and distribution of marketing content. Further, identifying the individual steps within the process may allow for a more granular understanding of where the generative AI may make an impact. For example, to create and distribute marketing content, the processor 202, along with the BCM, may perform marketing content planning, create marketing content, implement design and branding, conduct distribution and publish and carry out monitoring and analysis.

Further, the processor 202, along with the BCM, may perform a documenting process steps where each process step inputs, outputs, stakeholders, tool/systems used, and performance metrics may be documented. In other words, documenting process steps may be the function that records detailed information for each process step, including inputs, outputs, stakeholders, tools used, and performance metrics. In one example, input may be the data, resources, or materials required to initiate the process step. The output may be the result or output produced by the process step. The stakeholders may be individuals responsible for or involved in executing the process steps. The tools/systems used may be the systems or tools currently employed for each step. Performance metrics may be Key Performance Indicators (KPIs) used to measure the success of the step (e.g., time, accuracy, cost).

Further, the detailed process analysis for the process steps of performing marketing content planning, creating marketing content, implementing design and branding, conducting distribution and publishing, and carrying out monitoring and analysis is shown in Table 1:

TABLE 1

| | | | | | |
|---|---|---|---|---|---|
| | | | | Tools/ | |
| Process Step/ | | | Stake- | Systems | Performance |
| Step-level | Inputs | Outputs | holders | Used | Metrics |

Perform
Marketing
Content
Planning
Create
Marketing
Content
Implement
Design and
Branding
Conduct
Distribution
and Publishing
Carryout
Monitoring
and Analysis

Further, the performance of the detailed process analysis aids in identifying the inputs, outputs, stakeholders, tools used, and performance metrics for each step. This level of detail is essential to spot inefficiencies or opportunities where the generative AI may add value.

Further, by identifying the pain points, each process step may be analyzed to uncover inefficiencies, bottlenecks, or areas prone to errors. In other words, identifying pain points may be the function that analyzes each process step to identify inefficiencies, marking pain points for the generative AI. Tasks that may be repetitive, manual, or time-consuming are identified as these represent opportunities for the generative AI to significantly improve performance. Pain points identify specific challenges, inefficiencies, or errors within each step of a process, highlighting opportunities for improvement. A template for the pain point identification with regard to the process steps of performing marketing content planning, creating marketing content, implementing design and branding, conducting distribution and publishing, and carrying out monitoring and analysis is shown in Table 2:

TABLE 2

| | |
|---|---|
| Process Step | Pain Points |

Perform Marketing Content Planning
Create Marketing Content
Implement Design and Branding
Conduct Distribution and Publishing
Carryout Monitoring and Analysis

By identifying generative AI opportunities, each process step where the generative AI may provide the most value may be assessed while focusing on four key capabilities. Particularly, identifying generative AI opportunities may be the function that evaluates pain points to see where the generative AI can add value in four areas: search, summarization, creation, and validation. The four key capabilities may be search, summarization, creation, and validation.

Further, the generative AI intersecting with regard to the process steps of performing marketing content planning, creating marketing content, implementing design and branding, conducting distribution and publishing, and carrying out monitoring and analysis is shown Table 3:

TABLE 3

| | | | | |
|---|---|---|---|---|
| Process Step | Search | Summarization | Creation | Validation |

Perform Marketing
Content Planning
Create Marketing
Content
Implement Design and
Branding
Conduct Distribution
and Publishing
Carryout Monitoring
and Analysis

As shown in the Table 3, the process steps are mapped to the relevant generative AI capabilities such as the search, summarization, creation, or validation to ensure each generative AI application is aligned with the area where it can deliver the most value.

Further, a multi-layered validation may provide the generative AI opportunities that are evaluated across several dimensions, including desirability, feasibility, viability, adaptability, and compliance, ensuring robust implementations.

Further, a template for process validation with regard to the process steps of performing marketing content planning, creating marketing content, implementing design and branding, conducting distribution and publishing, and carrying out monitoring and analysis is shown in Table 4:

TABLE 4

| | | | | | | |
|---|---|---|---|---|---|---|
| | | | | | | Total |
| Process | Desirability | Feasibility | Viability | Adaptability | Compliance | Score |

Perform
Marketing
content Planning
Create
Marketing
Content
Implement
Design and
Branding
Conduct
Distribution and
Publishing
Carryout
Monitoring and
Analysis

The process steps are validated against 5 validation filters: desirability, feasibility, viability, adaptability, and compliance to arrive at a total score. Each filter helps assess whether it makes strategic sense to implement the generative AI in the process. The scale here is High=2, Medium=1, and Low=0.

A template for process prioritization and scoring with regard to process steps is shown in Table 5:

TABLE 5

| | | | | |
|---|---|---|---|---|
| Business Capability | Process Group | Process | Score | Priority |

| | | |
|---|---|---|
| Market Products and | Market to | Creation and |
| Services Capability | Customers | Distribution of |
| | | Marketing |
| | | Content |
| . . . | . . . | |

For instance, with regard to the process steps of performing marketing content planning, creating marketing content, implementing design and branding, conducting distribution and publishing, and carrying out monitoring and analysis. Herein, the processes may be ranked based on respective scores, focusing on the one with the highest potential impact and ease of implementation.

By profiling processes, aligning such processes with the generative AI capabilities, and applying the multi-layered validation process, enterprises may be able to ensure that respective generative AI initiatives are strategically sound, feasible, and impactful. The techniques of the present subject matter prevent fragmented efforts and prioritize high-impact, scalable AI use cases that deliver measurable business value.

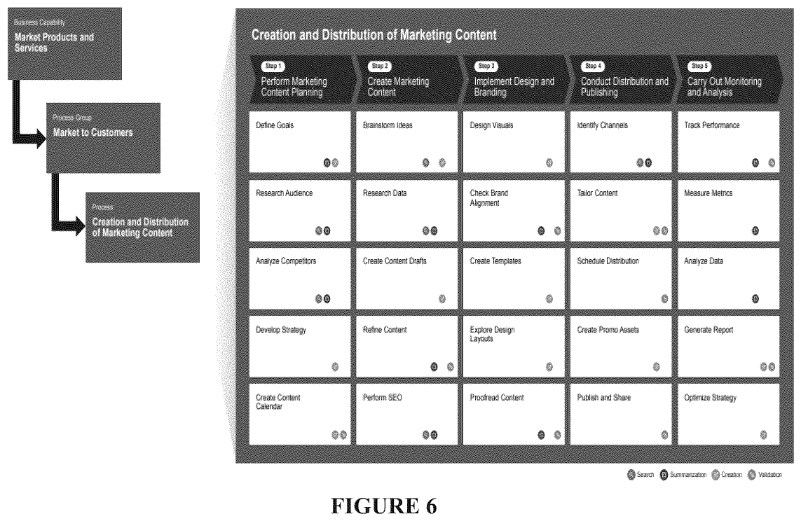

FIG. 6 illustrates an implementation of the process of creation and distribution of marketing content, in accordance with the embodiment of the present disclosure. In an example as illustrated in FIG. 6, the business capabilities for the process of creation and distribution of marketing content may be marketing products and services, the process group may be marketing to customers and the process may be creation and distribution of marketing content. FIG. 6 illustrates the steps for performing marketing content planning, steps for creating marketing content, steps for implementing design and branding, steps for conducting distribution and publishing, and the steps of carrying out monitoring and analysis. FIG. 6 shows an illustration of an implementation of the present subject matter when the process of creation and distribution of marketing content, however, the implementations of the present subject matter are not limited thereto.

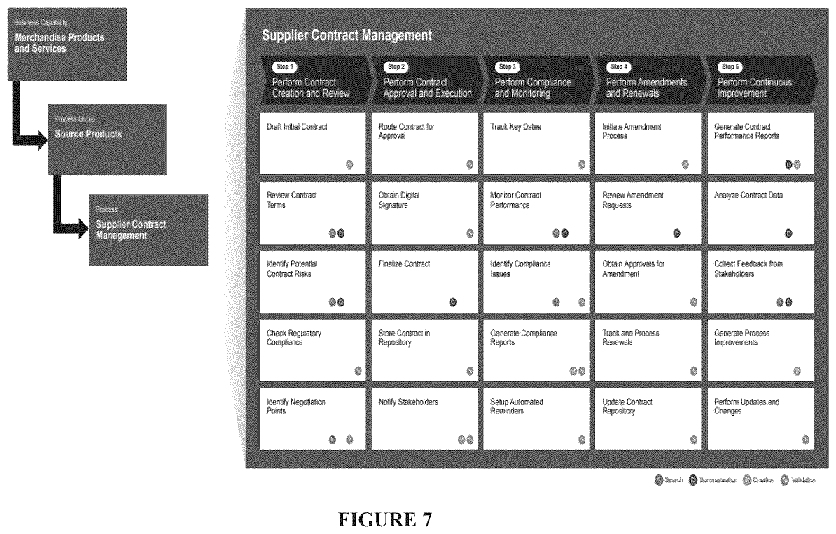

FIG. 7 illustrates an implementation of the process of supplier contract management, in accordance with the embodiment of the present disclosure. In an example as illustrated in FIG. 7, the business capabilities for the process of creation and distribution of marketing content may be merchandise products and services, the process group may be source products, and the process may be supplier contract management. FIG. 7 illustrates the steps for performing contract creation and review, steps for performing contract approval and execution, steps for performing compliance and monitoring, steps for performing amendments and renewals, and the steps of continuous improvements. FIG. 7 shows an illustration of an implementation of the present subject matter when the process is supplier contract management, however, the implementations of the present subject matter are not limited thereto.

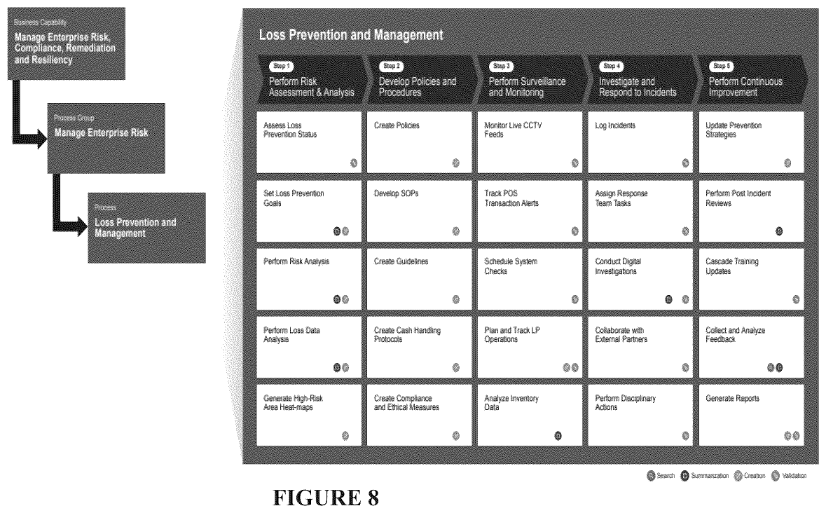

FIG. 8 illustrates an implementation of the process of loss prevention and management, in accordance with the embodiment of the present disclosure. In an example as illustrated in FIG. 8, the business capabilities for the process of creation and distribution of marketing content may be management enterprise risk, compliance, redemption, and resiliency. The process group may be managing enterprise risk, and the process may be loss prevention and management. FIG. 8 illustrates the steps for performing risk assessment and analysis, steps for developing policies and procedures, steps for performing surveillance and monitoring, steps for investigating and responding to incidents, and the steps for performing continuous improvement. FIG. 8 shows an illustration of an implementation of the present subject matter when the process is loss prevention and management, however, the implementations of the present subject matter are not limited thereto.

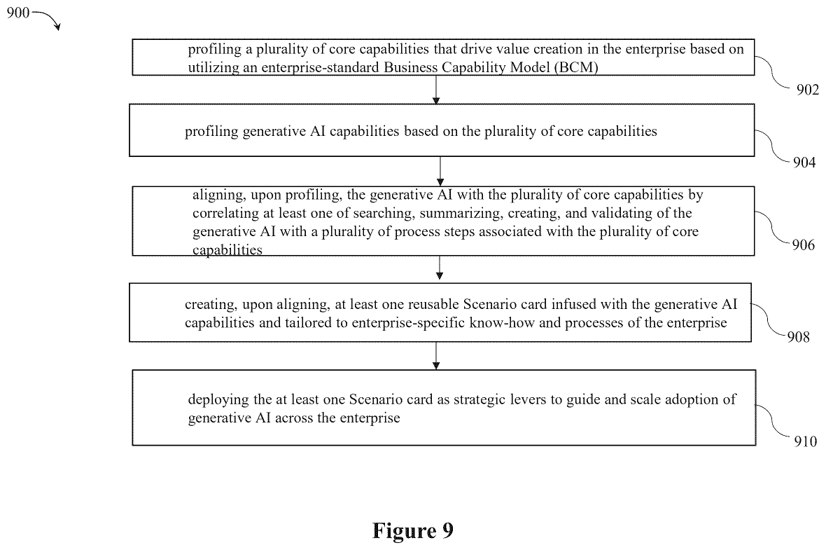

The method 900 includes a series of operations shown at step 902 through step 910 of FIG. 9. The method 900 may be performed by the system 104 in conjunction with processor 202, the details of which are explained with reference to FIGS. 2 to 8, and the same are not repeated here for the sake of brevity of the present disclosure. The method 900 begins at step 902.

At step 902, the method 900 includes profiling the plurality of core capabilities that drive value creation in the enterprise 102 based on utilizing the enterprise-standard Business Capability Model (BCM). The BCM may include the industry-standard framework selected from the predefined process classification framework.

The method 900 includes listing the plurality of core capabilities of the enterprise 102 based on an identification of the plurality of core capabilities. The method 900 includes profiling the plurality of core capabilities that drive value creation in the enterprise 102 based on utilizing the enterprise-standard BCM.

The method 900 includes forming the plurality of process steps associated with the plurality of core capabilities based on segmenting the plurality of core capabilities. The method 900 includes determining at least one task associated with the plurality of core capabilities based on the plurality of process steps.

At step 904, the method 900 includes profiling the generative AI capabilities based on the plurality of core capabilities.

The method 900 includes identifying the plurality of process steps corresponding to the plurality of core capabilities. The method 900 includes validating, upon identification, the plurality of process steps with respect to the plurality of criteria associated with the generative AI. The plurality of criteria may include desirability, feasibility, viability, adaptability, and compliance associated with the generative AI. The method 900 includes profiling the generative AI capabilities based on the validation.

At step 906, the method 900 includes aligning, upon profiling, the generative AI with the plurality of core capabilities by correlating at least one of searching, summarizing, creating, and validating of the generative AI with the plurality of process steps associated with the plurality of core capabilities.

The method 900 includes performing search by the generative AI based on assessment that the generative AI is able to retrieve information from the plurality of core capabilities. The method 900 includes performing summarization by the generative AI based on assessment that the generative AI is able to condense at least one of dataset or document associated with the plurality of core capabilities. The method 900 includes performing creation by the generative AI based on assessment that the generative AI is able to create new content or insights associated with the plurality of core capabilities based on user-input. The method 900 includes performing validation by the generative AI based on assessment that the generative AI is able to validate one of data or a result associated with the plurality of core capabilities.

The method 900 includes mapping the generative AI with each of the plurality of core capabilities based on correlating at least one of the searching, summarizing, creating, and validating of the generative AI with the plurality of process steps associated with the plurality of core capabilities. The method 900 includes assigning the suitability score for each mapping. The method 900 includes aligning the generative AI capabilities with the plurality of core capabilities based on the suitability score.

At step 908, the method 900 includes creating, upon aligning, at least one reusable scenario card infused with the generative AI capabilities and tailored to enterprise-specific know-how and processes of the enterprise 102.

The method 900 includes the at least one reusable scenario card may include process steps, system integration requirements, business rules, enterprise know-how, triggers, and actions for applying generative AI capabilities.

At step 910, the method 900 includes deploying the at least one reusable scenario card as strategic levers to guide and scale adoption of generative AI across the enterprise 102.

The present subject matter addresses the technical issues faced by the enterprise, by scaling the adoption of the generative AI in a strategic and effective manner. Many enterprises struggle with isolated or fragmented Generative AI implementation that fails to align with their core operations and strategic goals. By leveraging a BCM, the present subject matter ensures Generative AI is integrated seamlessly with existing processes, optimizing both efficiency and return on investment.

The present subject matter through the method and system illustrated hereinabove helps businesses integrate generative AI into their core processes, driving productivity, reducing manual labor, and enabling faster decision-making, directly contributing to business growth and operational efficiency. The present subject matter through the method and system illustrated hereinabove, ensures generative AI integration is scalable across the entire enterprise and adaptable to changing business needs, offering long-term utility. The present subject matter may be applied to a wide range of industries, with real-world applications in sectors such as retail, healthcare, asset management, and the like, thereby, enhancing utility across different business environments. Further, the present subject matter, through the method and system illustrated hereinabove, solves the real challenge of aligning Generative AI technologies with enterprises goals, ensuring smooth integration into existing workflows. Thus, the present subject matter offers a practical solution to a real-world problem i.e., scaling generative AI adoption within enterprises, by providing a structured and effective framework.

The conventional AI adoption frameworks fail to specifically leverage the BCM as done by the present subject matter. The present subject matter provides a unique structured method of profiling generative AI capabilities (such as search, summarization, creation, and validation) and validating them through a multi-stage process. Additionally, the present subject matter also provides a distinct concept of Scenario cards that are strategic levers for generative AI adoption in an enterprise. The present subject matter has scalability and adaptability, thereby allowing enterprises to adapt the same across various domains and operational sizes.

The present subject matter provides a combination of BCM with a methodical Generative AI adoption strategy. The BCM may be conventionally used for organizational design or process optimization, however, the present subject matter integrates BCM with Generation AI adoption. The scenario cards of the present subject matter may be reusable, modular strategic levers for scaling Generative AI adoption. The present subject matter includes techniques of the multi-stage validation process, evaluating the generative AI use cases based on the desirability, feasibility, viability, adaptability, and compliance that go beyond traditional methods of the generative AI deployment. Conventionally, many AI frameworks are domain-specific, however, the techniques including the method and the system of the present subject matter have scalability and flexibility and offer a comprehensive solution across industries and business sizes.

The present disclosure addresses the need of the enterprise for a systematic approach that aligns AI initiatives with their core business capabilities. The present subject matter provides a framework, along with a method and a system, designed to help enterprises adopt generative AI at scale using the BCM. The disclosed techniques may be highly adaptable, making them flexible and scalable across various industries and workflows. In other words, the present subject matter provides techniques that guide enterprises through the process of aligning AI initiatives with their core objectives, ensuring they maximize the value of generative AI technologies. By utilizing the BCM and Scenario cards, enterprises may be able to systematically identify opportunities for generative AI to enhance operations. The method and system of the present subject matter provide a well-defined path for embedding generative AI into core business operations, driving innovation, and enabling companies to maintain a competitive edge in an increasingly AI-driven world.

While specific language has been used to describe the present disclosure, any limitations arising on account thereto, are not intended. As would be apparent to a person in the art, various working modifications may be made to the method in order to implement the inventive concept as taught herein. The drawings and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment.

We claim:

1. A method (900) for strategic adoption of generative artificial intelligence (AI) within an enterprise (102), the method (900) comprising:
profiling (902) a plurality of core capabilities that drive value creation in the enterprise (102) based on utilizing an enterprise-standard Business Capability Model (BCM);
profiling (904) generative AI capabilities based on the plurality of core capabilities;
aligning (906), upon profiling, the generative AI with the plurality of core capabilities by correlating at least one of searching, summarizing, creating, and validating of the generative AI with a plurality of process steps associated with the plurality of core capabilities;
creating (908), upon aligning, at least one reusable scenario card infused with the generative AI capabilities and tailored to enterprise-specific know-how and processes of the enterprise (102); and
deploying (910) the at least one reusable scenario card as strategic levers to guide and scale adoption of generative AI across the enterprise (102).

2. The method (900) as claimed in claim 1, wherein the Business Capability Model comprises an industry-standard framework selected from a predefined process classification framework.

3. The method (900) as claimed in claim 1, wherein profiling the plurality of core capabilities comprises:
listing the plurality of core capabilities of the enterprise (102) based on an identification of the plurality of core capabilities; and
profiling the plurality of core capabilities that drive value creation in the enterprise (102) based on utilizing the enterprise-standard BCM.

4. The method (900) as claimed in claim 1, wherein upon profiling the plurality of core capabilities, the method (900) comprises:
forming a plurality of process step associated with the plurality of core capabilities based on segmenting the plurality of core capabilities; and
determining at least one task associated with the plurality of core capabilities based on the plurality of process steps.

5. The method (900) as claimed in claim 1, wherein profiling the generative AI capabilities comprises:
identifying a plurality of process steps corresponding to the plurality of core capabilities;
validating, upon identification, the plurality of process steps with respect to a plurality of criteria associated with the generative AI, wherein the plurality of criteria comprises desirability, feasibility, viability, adaptability, and compliance associated with the generative AI; and
profiling the generative AI capabilities based on the validation.

6. The method (900) as claimed in claim 1, wherein the method (900) comprises:
performing search by the generative AI based on assessment that the generative AI is able to retrieve information from the plurality of core capabilities.

7. The method (900) as claimed in claim 1, wherein the method (900) comprises:
performing summarization by the generative AI based on assessment that the generative AI is able to condense at least one of dataset or document associated with the plurality of core capabilities.

8. The method (900) as claimed in claim 1, wherein the method (900) comprises:
performing creation by the generative AI based on assessment that the generative AI is able to create new content or insights associated with the plurality of core capabilities based on user-input.

9. The method (900) as claimed in claim 1, wherein the method (900) comprises:
performing validation by the generative AI based on assessment that the generative AI is able to validate one of data or a result associated with the plurality of core capabilities.

10. The method (900) as claimed in claim 1, wherein aligning the generative AI with the plurality of core capabilities comprises:
mapping the generative AI with each of the plurality of core capabilities based on correlating at least one of the searching, summarizing, creating, and validating of the generative AI with a plurality of process steps associated with the plurality of core capabilities;
assigning a suitability score for each mapping; and
aligning the generative AI capabilities with the plurality of core capabilities based on the suitability score.

11. The method (900) as claimed in claim 1, wherein the at least one reusable scenario card comprises process steps, system integration requirements, business rules, enterprise know-how, triggers, and actions for applying generative AI capabilities.

12. A system (104) for strategic adoption of generative artificial intelligence (AI) within an enterprise (102), the system (104) comprising:
a memory (204);
at least one processor (202) in communication with the memory (204), the at least one processor (202) configured to:
profile a plurality of core capabilities that drive value creation in the enterprise (102) based on utilizing an enterprise-standard Business Capability Model (BCM);
profile generative AI capabilities based on the plurality of core capabilities;
align, upon profiling, the generative AI with the plurality of core capabilities by correlating at least one of searching, summarizing, creating, and validating of the generative AI with a plurality of process steps associated with the plurality of core capabilities;
create at least one reusable Scenario card infused with the generative AI capabilities and tailored to enterprise-specific know-how and processes of the enterprise (102); and
deploy the at least one reusable scenario card as strategic levers to guide and scale adoption of generative AI across the enterprise (102).
